(19) United States
(12) Patent Application Publication
(10) Pub. No.: US 2015/0221974 A1
(43) Pub. Date: Aug. 6, 2015

(54) BATTERY REINFORCED POLYMER COMPOSITE SMART STRUCTURE

(71) Applicant: KALPTREE ENERGY, INC., Pleasanton, CA (US)

(72) Inventors: Deepak Upadhyaya, Fremont, CA (US); Mark Isaacson, Santa Clara, CA (US); Michael D. Sword, Concord, CA (US); Gregory D. Hitchan, Pleasanton, CA (US); Brook E. Van Muijen, Danville, CA (US)

(73) Assignee: KALPTREE ENERGY, INC., Pleasanton, CA (US)

(21) Appl. No.: 14/613,732

(22) Filed: Feb. 4, 2015

Related U.S. Application Data
(60) Provisional application No. 61/935,440, filed on Feb. 4, 2014.

(51) Int. Cl. H01M 10/04; H01M 10/0587; H01M 10/0565

(52) U.S. Cl. CPC H01M 10/0431; H01M 10/0565; H01M 10/0587; H01M 10/0525

(57) ABSTRACT

A battery having a laminate structure of alternating layers of polymer matrix material and solid-state battery elements is fabricated. Individual solid-state battery elements are created in a deposition apparatus, each battery element having successive solid-state thin films concentrically formed over a conductive wire substrate to define anode, electrolyte and cathode active layers sandwiched between inner and outer current collectors. Inner current collectors are electrically coupled to each other (and likewise the outer current collectors) such that battery elements are connected in a specified series and parallel arrangement. Sets of the individual battery elements are laid upon cloth layers such that outer current collectors of the battery elements physically contact the cloth and the cloth layers are impregnated with selected thermoplastic or thermosetting resin, the impregnated cloth layers and their respective contacting battery elements are stacked to form a composite laminate. The laminate is compacted and cured, and the battery elements of the various layers are coupled to external electrodes. The battery elements double as load components for the laminate structure.

### CROSS-REFERENCE TO RELATED APPLICATION

This application claims priority under 35 U.S.C. 119(e) from U.S. provisional application Ser. No. 61/935,440 filed Feb. 4, 2014.

### TECHNICAL FIELD

The present invention relates to lithium ion batteries, particularly those of the solid-state type, and together with associated load-bearing structural elements.

### BACKGROUND ART

Rechargeable lithium ion batteries (LIBs) are widely used in various kinds of portable electronic devices, medical devices and power tools and are being considered for use in electric vehicle. However, batteries add significant weight and volume to devices. The consolidation of battery and structure can reduce the total weight by exploiting the battery components as load-bearing elements and by eliminating battery fittings or supports. However, traditional liquid electrolyte LIBs cannot easily be integrated within the structure of reinforced polymer composites due to limitations imposed by the high curing temperatures of reinforced polymer composite.

Recently, solid-state thin film Li-ion batteries (SSBs) have been proposed as load bearing structure. SSBs offer fast charge and discharge rates and high cycle life with little capacity fades and operate over a much wider temperature range than conventional LIBs. They can also be easily fabricated with very thin cross section and can therefore be integrated into thin structural sections. However significant weight fraction of inactive passive material components, such as the packaging, makes traditional SSBs unsuitable for most applications. Additionally, these SSBs do not act as a load bearing component of structure as the transverse strength properties of the flat substrate being used are typically poor.

If the battery and packaging consist of an active load-bearing element eliminating passive battery mass, then SSBs can become an appealing multifunctional smart structure for many applications. Thus, there is a need for a safe high energy density of SSB that is a load bearing component within a smart polymer composite structure allowing a signification reduction in device weight.

### SUMMARY OF DISCLOSURE

The present invention teaches a battery and a method of fabricating and assembling the same with a structure forming a battery reinforced polymer composite. Deposition process equipment as well as Operations needed to fabricate a thin-film battery on flexible substrate are described.

A solid state battery reinforced polymer composite smart structure is provided wherein a battery performs as a load bearing component along the length and/or transverse direction. The battery may comprise an electrically conductive substrate with a defined cross-section, an (optional) adhesion layer, a positive electrode layer, an electrolyte layer, a negative electrode layer and an outer current collector. A thermal chemical vapor deposition process may be used to concentrically nucleate and grow the adhesion layer, positive electrode, electrolyte and negative electrode layer on a heated substrate along the length dimension, thereby forming an electrochemical battery cell. The individual battery element can have a length-to-diameter aspect ratio greater than 4000:1.

The battery element thus formed is surrounded by a polymer matrix material, which may consist of thermoplastic or thermosetting resin. In particular, individual battery elements within a laminate may be connected together such that the outermost (negative) electrode current collectors are in physical contact and connected to an external (negative) terminal, while all substrate ends may be connected at an external (positive) terminal. Alternatively, individual battery elements within a laminate may be connected together such that the outermost (negative) electrode current collectors are connected together using an electrical conductive wire and connected to the external negative terminal, while all substrate ends are connected at the external positive terminal. The laminate can be in woven cloth form. The reinforcing battery provides a high stiffness and strength, as well as dimensional stability to the composite structure. Preferably, the battery volume fraction will comprise about 50% to 90% of the overall volume of the composite structure.

The laminate structure may be stacked with battery elements having alternately (1) thinner active layers to increase device power density (power laminate) and (2) with thicker active layers to increase device energy density (energy laminate). Every individual battery elements within a given individual layer of the laminate may be of the same length-to-diameter aspect ratio, but the diameters of their respective substrates can vary from 10 μm to 100 μm to increase the packing density of the bundle or the thicknesses of the battery active layers can vary to increase the charge-discharge rate. The battery reinforced polymer composite can be fabricated by stacking individual battery reinforced laminates in a predetermined molded shape.

### BRIEF DESCRIPTION OF THE DRAWINGS

FIG. 1 is a schematic plan view of a thermal vapor deposition reactor with multiple deposition chambers connected in series and isolated from ambient to fabricate a solid state electrochemical cell.

FIG. 2a is a side sectional view of a solid state electrochemical cell structure consisting of a positive electrode, electrolyte, negative electrode structure and current collector with length-to-diameter ratio (L:D) greater than 4000:1.

FIG. 2b is a schematic side view illustrating the formation of unidirectional battery cloth, where individual battery elements are together such that the outermost (e.g. negative) electrode current collectors are in electrical contact all other like-polarized electrode current collectors and connected to the external terminal, while all substrate ends are connected at the external (positive) terminal. The identities of the respective positive and negative electrodes and their corresponding current collectors in another embodiment may be reversed.

FIG. 2c is a perspective schematic view illustrating assembling of the single layer unidirectional battery cloth laminate prepreg (i.e., the cloth laminate prior to polymer resin impregnation).

FIG. 2d is a perspective schematic view illustrating the fabrication of battery reinforced polymer composite smart structure with multiple prepregs of FIG. 2c stacked together.

FIG. 3 is a perspective cut-away view of a high-power/high-energy-density battery reinforced polymer composite smart structure.

FIGS. 4a, 4b and 4c are perspective views showing various applications of the battery reinforced smart structure as in FIG. 3 for a vehicle, tablet casing and wearable watch electronics, respectively.

### DETAILED DESCRIPTION

An embodiment of the present invention relates to using a thermal chemical vapor deposition process (TCVD) to nucleate and sequentially grow concentric layers of cathode, electrolyte, anode and anode current collector onto an electrically conductive solid substrate with a circular cross-sectional. The electrically conductive substrate acts as a current collector for the cathode during battery charging and discharging. In this embodiment, deposition of the anode layer onto the electrolyte layer allows outwardly volumetric expansion of anode constituents during the intercalation-deintercalation processes. (Note: in other embodiments the cathode and anode layers may be reversed.) One further advantage of concentric layer deposition over a circular substrate is that it minimizes mechanical stress non-uniformities within the deposited material as compared to flat substrates used in traditional SSB fabrication.

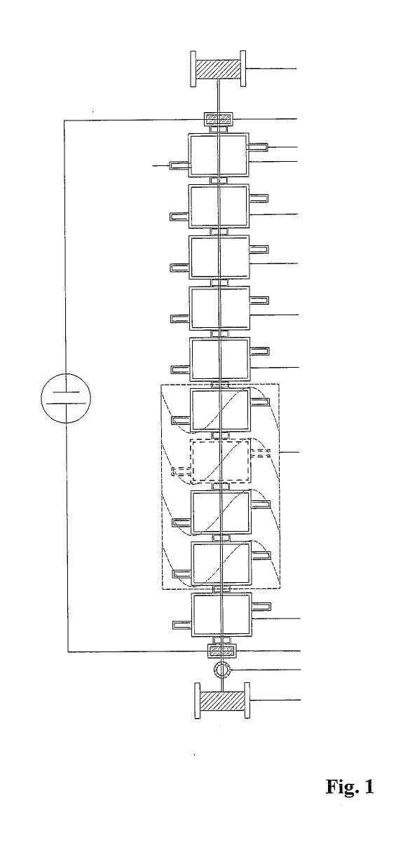

As seen in FIG. 1, a vertical TCVD tubular deposition apparatus (reactor) has a circular cross section with internal diameter ranging from 1 mm to 100 mm. In this fabrication method, the substrate is continuously drawn through the multiple section deposition chambers. The unique design features of the reactor (e.g. small diameter and continuously moving substrate) reduce defects and increases deposit uniformity. This level of uniformity is not possible with traditional physical, chemical, sol-gel or spray deposition methods. Depending upon the reaction precursor introduced within each apparatus section, a thin film is formed consisting of concentric layers in intimate contact. FIG. 1 depicts a continuous electrically conductive substrate moving through the deposition chamber(s). The reactor is heated by passing electrical current through the substrate. The desired temperature range is controlled by varying the current through the substrate as well as varying the amount of cooling gases introduced within each section of reactor and ranges from 300 to 1200 Degree Celsius. Using a long tubular CVD apparatus gives high consumption of deposition precursor and ultra-high growth rate as most of the input precursor is consumed before the reactant gas mixture exits from the reactor. The precursor compounds thermally decompose at pressures ranging from 1-600 torr. The thickness of each deposited layer can be controlled by varying the length of each reactor section (typically about 7.5 cm to about 1 meter), the reactant gas flow rates, the heated substrate temperature and the speed of the moving substrate (typically 5 meter/second to 200 meter/second). Exhaust gasses are pumped through ports, with port maintaining separation of atmosphere between chambers. A CVD reactor with up to 15 sections is envisioned in order to deposit the multiple cathode, electrolyte, anode and current collector layers required for an optimized electrochemical cell. Tensioners may be used to control the tension of the wire and the substrate feed and collected on reels. A differential pressure and argon curtain or vacuum chamber based mechanism is used to provide atmospheric isolation of reaction chamber.

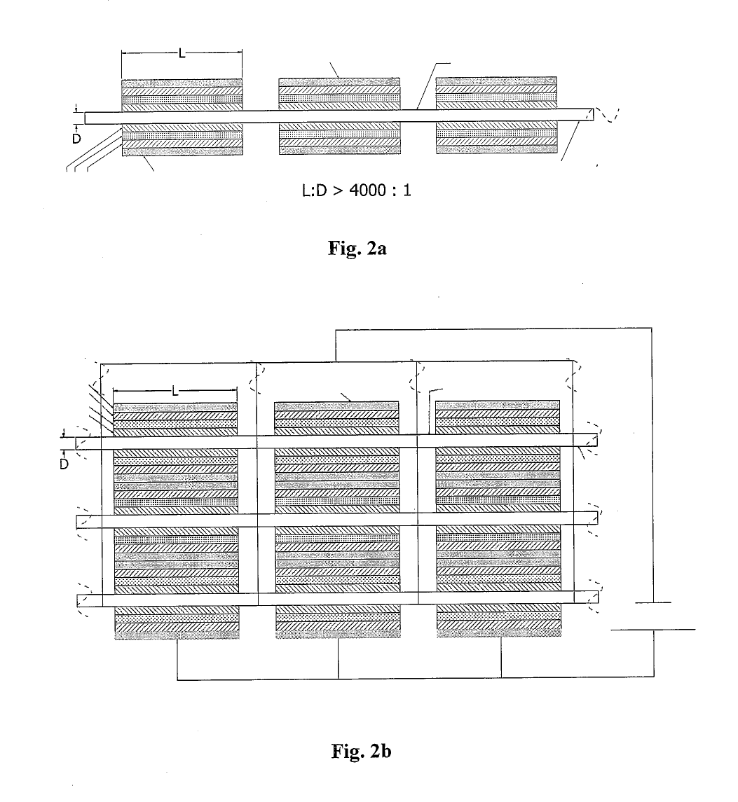

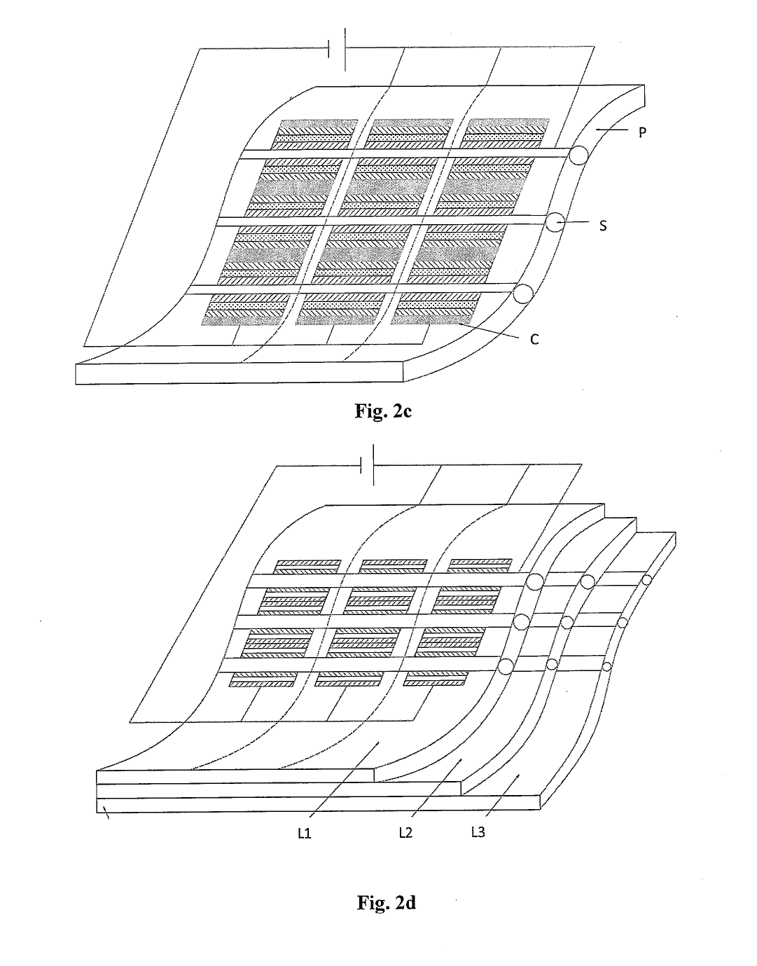

As per the above teachings, the deposition process results in the continuous deposition of cathode, electrolyte, anode and current collector layers along the length of substrate without any provision for the electrical connections required for a functioning electrochemical cell. A unique method is presented that allows removal of deposited material exposing the substrate underneath at desired locations, as seen in FIG. 2a. This allows attachment of electrical connections to the conductive substrate and fabrication of an electrochemical cell of the desired length. In the embodiment shown in FIG. 2a, the thin film solid state battery may have a length-to-diameter ratio (L:D) greater than 4000:1. This is achieved by modifying the surface energy and chemistry of the substrate at selected locations such that coating does not adhere (bond) to the substrate. This allows debonding of deposited material from the substrate at locations where the surface energy was modified due to thermal stresses that arise as the substrate cools as it exits the reactor. The surface energy of the substrate at the desired locations can be modified with traditional methods such as sand blasting to impart a tensile stress state or applying an evaporative dye. The distance between the debonded or exposed section along the length of the substrate can vary as per the required electrode length.

Using the method and process described above, a unique solid state electrochemical cell is formed by sequentially depositing concentric layers consisting of an adhesion/reaction barrier, a positive electrode, a solid state electrolyte, a negative electrode and outermost current collector. In such electrochemical cell structure, the electrolyte layer performs both as an ion conductor and an electronic insulator between the positive and negative electrodes. Referring still further to FIGS. 1 and 2a, in one embodiment of the concentric layers of active component of solid state Li-ion battery is formed onto an electrically conductive substrate using the following steps:

1. Modification of the surface energy of the substrate at selected locations along the length prior to entering the deposition section of the reactor;
2. Resistive heating of the substrate and etching of the native oxide (if any);
3. (Optional) Nucleation and concentric growth of an electrically conductive thin layer onto the heated substrate serving the purpose of providing an adhesion layer (bonding layer) and a reaction and diffusion barrier function between the substrate and the subsequent coating;
4. Nucleation and concentric growth of first electrode layer (such as a positive electrode or cathode layer) onto the bond layer;
5. An optional in-situ elevated thermal annealing of deposited positive electrode to produce the desired crystal structure or chemical composition;
6. Nucleation and concentric growth of an electrolyte layer electrode onto the positive electrode layer;
7. Nucleation and concentric growth of the second (e.g. negative) electrode onto the electrolyte layer;
8. Deposition of the outer (negative) electrode current collector electrode onto the second electrode using precursors of a selected conductive metal, such as Al, Ag, Ti, Cu, or W, or alloys of the same;
9. Debonding of deposited coating from the substrate at selected location during cool down at the exit section of reactor exposing the substrate, yielding the cell structure seen in FIG. 2a.

### Fabrication and Assembly of a Battery Reinforced Polymer Composite Smart Structure

An embodiment of the present invention relates to fabricating a battery reinforced polymer composite smart structure using the following steps:

1. Create an individual solid state battery as per the teaching described above (FIG. 2a);
2. Weave a cloth of desired size (length and width) such that negative current collector of individual battery element is touching each while a metallic cross wire connects individual substrate at debonded areas (FIG. 2b);
3. Create a single battery reinforced prepreg laminate by impregnating battery cloth from step 2 with desired thermoplastic or thermosetting resin (FIG. 2c);
4. Create a composite prepreg by stacking several layers of single prepreg laminate from step 3;
5. Place composite laminate from step 4 in a sealable vacuum bag, pull vacuum to remove air to compact the part and seal the assembled structure;
6. Cure the assembled structure from step 5 in a autoclave or oven using a combination of heat, pressure, vacuum, and inert atmosphere to form battery reinforced polymer composite smart structure (FIG. 2d); and
7. Remove the sealing bag and make electrical connection such that negative current collector of individual battery is connected to an electric terminal while positive current collector is connected to second electric terminal (FIG. 3).

In present invention, the energy density of a solid state electrochemical cell depends upon the thickness of active layers as well as length-to-diameter aspect ratio (FIG. 2a). To increase energy density, in one embodiment low energy density battery elements with aspect ratio greater than 4000:1 are assembled to form a prepreg laminate as per the teaching described above. Thus, an aspect ratio higher than 4000:1 may be needed so that each solid state battery element meet minimum energy density threshold to maintain low cost of manufacturing such as cost of making electrical connection.

In this invention, the modular nature of assembling battery provides the capability to optimize cell design on multiple parameters simultaneously by varying substrate wire diameter, thin-film coating thicknesses, and thin-film coating structures. As depicted in FIG. 3, the proposed fabrication method allows use of multiple thicknesses of active material layers within a battery reinforced composite. For example, one prepreg laminate consist of woven cloth with thinner active material while other consist of thicker active material layers. This will result in a cascading power output with prepreg laminate with battery element thinner active material discharging more rapidly than the prepreg laminate with thicker active material layer. Thus, this invention enables assembly of various combinations of individual battery allowing a nearly infinite capability to tune capacity and charge-discharge rates for specific applications. An embodiment of such invention include fabrication of a battery reinforced composite by stacking alternate layers of high power density laminate (power laminate) and high energy density laminate (energy laminate).

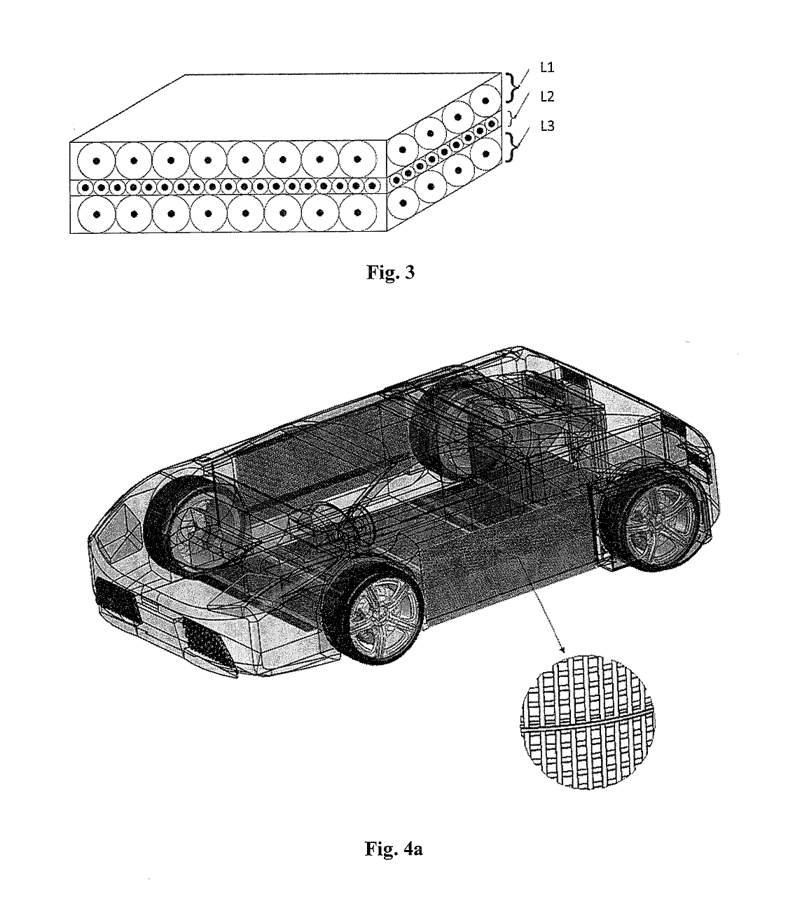

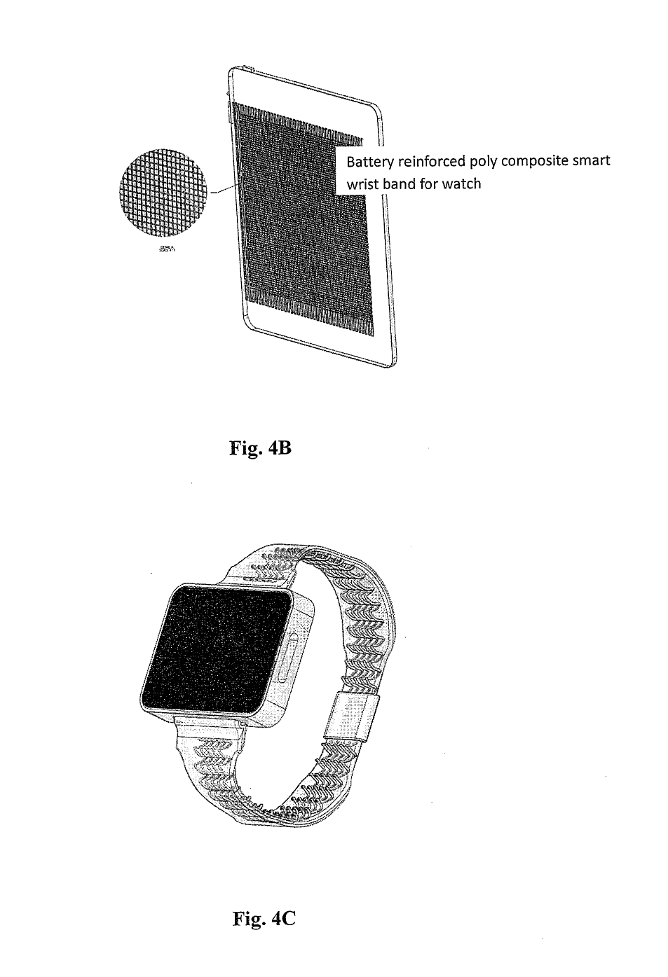

Embodiments of the present invention also offer a high degree of flexibility as compared with conventional approaches and offer significant advantages such as molded and shaped battery reinforced composite smart structure. The battery reinforced smart polymer composite structure may be applied in a variety of applications, including vehicles (such as on vehicle bodies), electronics (such as casings for tablets) or wearable products (such as wristbands for watches), as illustrated in FIGS. 4a to 4c.

What is claimed is:

1. A battery, comprising:
a laminate structure of alternating layers of polymer matrix material and solid-state battery elements, each battery element having successive solid-state thin films concentrically formed over a conductive wire substrate which define anode, electrolyte and cathode active layers sandwiched between inner and outer current collectors, the inner current collectors of the battery elements electrically coupled to each other and the outer current collectors of the battery elements likewise electrically coupled to each other such that battery elements are connected in a specified series and parallel arrangement.

2. The battery as in claim 1, wherein the polymer matrix material layers comprise a woven cloth impregnated with a thermoplastic or thermosetting resin.

3. The battery as in claim 1, wherein outer current collectors of battery elements in the same layer are in contact with adjacent polymer matrix material layers.

4. The battery as in claim 1, wherein the conductive wire substrates forming inner current collectors of battery elements are connected to each other at wire substrate ends.

5. The battery as in claim 1, wherein inner current collectors of battery elements in the same layer are electrically coupled via at least one metallic cross wire at a set of exposed debonded areas of the battery elements.

6. The battery as in claim 1, wherein individual battery elements are characterized by a length to diameter aspect ratio greater than 4000:1.

7. The battery as in claim 1, wherein the conductive wire substrates of the respective battery elements have varying diameters in a range from 10 μm and 100 μm.

8. The battery as in claim 1, wherein active layers of the respective battery elements have differing thicknesses from one element to the next to provide varying charge-discharge rates.

9. The battery as in claim 8, wherein alternate layers of battery elements in the laminate structure have alternately thicker and thinner active layer thicknesses.

10. The battery as in claim 1, wherein battery elements comprise between 50 and 90 percent of total volume of the laminate structure.

11. The battery as in claim 1, wherein battery elements also perform as load-bearing components along a length direction defined by the wire substrates of the battery elements of at least one layer in the laminate structure.

12. The battery as in claim 1, wherein battery elements also perform as load-bearing components along a direction transverse to the wire substrates of the battery elements of at least one layer in the laminate structure.

13. A solid-state battery reinforced polymer composite smart structure, comprising:
a plurality of individual solid-state battery elements, each battery element having successive solid-state thin films concentrically formed over a conductive wire substrate which define anode, electrolyte and cathode layers sandwiched between inner and outer current collectors;
a plurality of layers of polymer matrix material of woven cloth impregnated with a thermoplastic or thermosetting resin, each layer in contact with outer current collectors of a specified subset of the battery elements, the conductive wire substrates forming inner current collectors of the same specified subset of battery elements being connected to a metallic cross wire at debonded areas of the battery elements, alternate layers of the woven cloth and their contacting subsets of battery elements being stacked in an assembled composite structure.

14. A method of making a battery having a laminate structure, comprising:
creating a plurality of individual solid-state battery elements, each battery element having successive solid-state thin films concentrically formed over a conductive wire substrate which define anode, electrolyte and cathode active layers sandwiched between inner and outer current collectors;
laying sets of the individual solid-state battery elements upon cloth layers such that outer current collectors of the battery elements physically contact the cloth and impregnating the cloth layers with a selected thermoplastic or thermosetting resin;
stacking the impregnated cloth layers and their respective contacting battery elements to form a composite laminate of alternating layers of impregnated cloth layers and solid-state battery elements;
sealing the composite laminate stack within a vacuum bag and removing air so as to compact the laminate;
thermally curing the stack; and
removing the cured laminate stack from the vacuum bag and making electrical connections such that the inner current collectors of the battery elements electrically coupled to each other and the outer current collectors of the battery elements likewise electrically coupled to each other in a specified series and parallel arrangement.

15. The method as in claim 14, wherein the conductive wire substrates forming inner current collectors of battery elements are connected to each other at wire substrate ends.

16. The method as in claim 14, wherein inner current collectors of battery elements in the same layer are electrically coupled when laying the battery elements upon the cloth by providing metallic cross wires in contact with exposed wire substrate at a set of debonded areas of the battery elements, the inner current collectors being electrically coupled to each other in a specified series and parallel arrangement by a connection of the respective cross wires.

17. The method as in claim 14, wherein outer current collectors of battery elements in the same layer are in contact with adjacent polymer matrix material layers.

18. The method as in claim 14, wherein individual battery elements are characterized by a length to diameter aspect ratio greater than 4000:1.

19. The method as in claim 14, wherein the conductive wire substrates of the respective battery elements have varying diameters in a range from 10 μm and 100 μm.

20. The method as in claim 14, wherein active layers of the respective battery elements have differing thicknesses from one element to the next to provide varying charge-discharge rates.

21. The method as in claim 20, wherein alternate layers of battery elements in the laminate structure have alternately thicker and thinner active layer thicknesses.
